(19) United States
(12) Patent Application Publication
(10) Pub. No.: US 2020/0407552 A1
(43) Pub. Date: Dec. 31, 2020

(54) POLYESTER COMPOSITION

(71) Applicant: FAR EASTERN NEW CENTURY CORPORATION, Taipei City (TW)

(72) Inventors: Kuan-Liang WEI, Taipei City (TW); Chuan-Hao HSU, Taipei City (TW); Jui-Yun TSAI, Taipei City (TW); Tsang-Pin CHEN, Taipei City (TW)

(21) Appl. No.: 16/701,659

(22) Filed: Dec. 3, 2019

(30) Foreign Application Priority Data
Jun. 27, 2019 (TW) 108122593

(51) Int. Cl. C08L 67/02; C08G 63/183; C08K 5/098; C08F 236/10; C08F 4/70

(52) U.S. Cl. CPC C08L 67/025; C08G 63/183; C08K 5/098; C08L 2310/00; C08F 4/7096; C08L 2201/08; C08F 236/10

(57) ABSTRACT

A polyester composition includes a polyester, a copolyester-ether, a styrene-butadiene copolymer, and a catalyst. The styrene-butadiene copolymer includes a butadiene monomer unit which is in an amount ranging from 12 wt % to 50 wt % based on a total weight of the styrene-butadiene copolymer. The styrene-butadiene copolymer is in an amount ranging from 0.2 to 4 parts by weight based on 100 parts by weight of the polyester.

### CROSS-REFERENCE TO RELATED APPLICATION

This application claims priority of Taiwanese Invention Patent Application No. 108122593, filed on Jun. 27, 2019.

### FIELD

This disclosure relates to a polyester composition, and more particularly to a polyester composition having an oxygen-scavenging effect.

### BACKGROUND

Polyesters such as polyethylene terephthalate (PET) and polybutylene terephthalate (PBT) are known to have advantages such as non-toxic, odorless, high transparency, chemical stability, flexibility, low production costs, recyclability, high tear resistance, high production efficiency, etc. and thus, such polyesters are widely used in various fields. However, the use of unmodified polyesters is limited due to its insufficient oxygen barrier properties, and therefore, improving the oxygen barrier properties thereof remains a goal to be achieved.

An example of a subsequent application of polyesters would be packaging materials. When packaging materials made of unmodified polyesters are used for containing oxygen-sensitive food products such as miso, beer, etc., due to the lack of oxygen barrier properties of the un-modified polyesters, oxidation reactions with the oxygen-sensitive food may easily occur, causing easy food spoilage. Existing techniques to improve oxygen barrier properties thereof are categorized as passive oxygen barrier techniques and active oxygen-scavenging techniques. Specifically, the active oxygen-scavenging techniques involve adding oxygen-reactive substances into polyesters to form oxygen-scavenging polyester materials for processing into packaging materials, in which oxygen is consumed by the oxygen-reactive substances so that oxidation reaction with oxygen-sensitive food might be prevented. In practice, packaging materials made of such oxygen-scavenging polyester materials requires a period of time before effective oxygen-scavenging takes place, which is termed as an oxygen-scavenging induction period. The shorter the oxygen-scavenging induction period, the higher the efficiency of oxygen-scavenging, and thus more likely food spoilage can be prevented. In addition, industrial applications of such packaging materials further require high transparency for favorable appearance thereof.

U.S. Pat. No. 6,455,620 B1 discloses a compounding material including a polyester, a cobalt-containing catalyst, and a polyester-polyether copolymer for oxygen-scavenging. However, packaging material made with the compounding material has a relatively long oxygen-scavenging induction period, and thus might not be favorable as the packaging material for oxygen-sensitive food.

U.S. Pat. No. 8,647,728 B2 discloses a composition including a polyester, a copolyester ether, and an oxidation catalyst for shortening the oxygen-scavenging induction period of packaging materials made from the composition. The copolyester ether includes zinc compound, and at least one polyether segment selected from the group consisting of poly(tetramethylene ether) and poly(tetramethylene-co-alkylene ether). However, the zinc compound of the copolyester ether might induce pyrolysis reaction in the composition during processing under high temperature, resulting in a decrease in the physical properties of the thus manufactured products.

An example of a commercially available oxygen scavenger that might be added into PET is Amosorb DFC 4020E supplied by ColorMatrix, U.S. The oxygen scavenger is a modified copolyester including at least one polybutadiene segment, in which the polybutadiene can be rapidly oxidized to achieve immediate oxygen-scavenging effect. However, although polyester materials added with such oxygen scavenger might have shorter oxygen-scavenging induction periods, such polyester materials still exhibit high haze, which might adversely affect applications of the polyester materials as packaging materials.

### SUMMARY

Therefore, an object of the disclosure is to provide a polyester composition so as to alleviate or eliminate the aforesaid shortcoming of the prior art.

According to the disclosure, a polyester composition includes a polyester, a copolyester-ether, a styrene-butadiene copolymer, and a catalyst. The styrene-butadiene copolymer includes a butadiene monomer unit in an amount ranging from 12 wt % to 50 wt % based on a total weight of the styrene-butadiene copolymer, and the styrene-butadiene copolymer is in an amount ranging from 0.2 to 4 parts by weight based on 100 parts by weight of the polyester.

### DETAILED DESCRIPTION

In the following description, the term “oxygen-scavenging” refers to the ability of consuming or depleting oxygen through reactions to reduce oxygen level.

A polyester composition according to the disclosure includes a polyester, a copolyester-ether, a styrene-butadiene copolymer, and a catalyst.

The polyester may be any product of polycondensation reactions between diols and diacids, or between diols and diesters, and may include, but are not limited to, polyethylene terephthalate (PET), polybutylene terephthalate (PBT), polyethylene naphthalate (PEN), polyethylene furanoate (PEF), and combinations thereof.

The styrene-butadiene copolymer includes a styrene monomer unit and a butadiene monomer unit. The butadiene monomer unit is in an amount ranging from 12 wt % to 50 wt % based on a total weight of the styrene-butadiene copolymer. In certain embodiments, the butadiene monomer unit is in an amount ranging from 15 wt % to 40 wt %. The styrene-butadiene copolymer is in an amount ranging from 0.2 to 4 parts by weight based on 100 parts by weight of the polyester. In certain embodiments, the styrene-butadiene copolymer is in an amount ranging from 0.5 to 3 parts by weight based on 100 parts by weight of the polyester.

No specific requirements are imposed on the weight-average molecular weight and the intrinsic viscosity of the styrene-butadiene copolymer. In certain embodiments, the styrene-butadiene copolymer has a weight-average molecular weight ranging from 100,000 g/mol to 200,000 g/mol, and an intrinsic viscosity ranging from 0.1 dl/g to 0.8 dl/g.

No specific structural requirements are imposed on the molecular structure of the styrene-butadiene copolymer. Both linear and branched styrene-butadiene copolymers are suitable for the embodiment of the disclosure, among which the branched styrene-butadiene copolymer may be, but is not limited to, star-shaped and comb-shaped.

The styrene-butadiene copolymer may be purchased as a commercial product or synthesized by any process well-known in the art. Such a process may be, but is not limited to, anionic polymerization of a mixture containing a styrene monomer, a butadiene monomer, and an initiator such as butyllithium (BuLi).

The copolyester-ether includes a polyester segment and a polyether segment. Examples of the polyester segment may include, but are not limited to, a PET segment, a PBT segment, and the like. Examples of the polyether segment may include, but are not limited to, a polyethylene glycol (PEG) segment, a polytetramethylene ether glycol (PTMEG) segment, and the like.

No specific characteristic requirements are imposed on the copolyester-ether. In certain embodiments, the polyether segment of the copolyester-ether may have a weight-average molecular weight ranging from 1000 g/mol to 3000 g/mol. In certain embodiments, the polyether segment may be in an amount ranging from 10 wt % to 70 wt % based on a total weight of the copolyester-ether. A product made with the polyester composition of the disclosure may exhibit a better oxygen-scavenging effect when the polyether segment is in an amount of not less than 10 wt %, and the copolyester-ether may have a crystallinity high enough for better processing (e.g., easier granulation) when the polyether segment is in an amount of not more than 70 wt %.

The copolyester-ether may be purchased as a commercial product or synthesized by any process well known in the art.

In certain embodiments, the copolyester-ether includes a PET segment and a PTMEG segment, and is made by subjecting dimethyl terephthalate, ethylene glycol, and PTMEG to a polycondensation reaction under the presence of a polycondensation catalyst.

In certain embodiments, the copolyester-ether is in an amount ranging from 0.5 to 3.0 parts by weight based on 100 parts by weight of the polyester.

The term “catalyst” refers to an oxidation catalyst that promotes oxidation reactions. In the polyester composition of the disclosure, the catalyst is used to promote oxidation reaction of the copolyester-ether and the styrene-butadiene copolymer with oxygen. In certain embodiments, the catalyst includes a transition metal. More particularly, the catalyst includes an ionic compound of a transition metal. The catalyst includes the transition metal and a counterion of the transition metal. The transition metal may be, but is not limited to, cobalt, copper, rhodium, ruthenium, palladium, tungsten, osmium, cadmium, silver, tantalum, hafnium, vanadium, titanium, nickel, manganese and combinations thereof. The counterion of the transition metal may be, but is not limited to, neodecanoate, stearate, and acetate. In certain embodiments, the transition metal includes cobalt. In certain embodiments, the catalyst is a cobalt-containing catalyst, which may be cobalt acetate, cobalt neodecanoate and the combination thereof. No specific limitations are imposed on the amount of the catalyst as long as the technical outcome of the disclosure is not adversely affected. In certain embodiments, the transition metal is in an amount ranging from 0.003 to 0.01 part by weight based on 100 parts by weight of the polyester, such that a product made from the polyester composition of the disclosure can have a shorter oxygen-scavenging induction period, and such that the color of the transition metal may not have an effect on the color of the product.

Based on the requirements for subsequent applications, the polyester composition of the disclosure may optionally include additives such as, but are not limited to, colorants, anti-static agents, flame retardants, anti-ultraviolet agents, slip proofing agents, plasticizers, inorganic fillers, antioxidants, lubricants, cross-linking agents, and combinations thereof. No specific limitations are imposed on the amount of the additives, for example, the additive may be in an amount ranging from 0 to 30 parts by weight based on 100 parts by weight of the polyester in the polyester composition according to the disclosure.

The polyester composition of the disclosure may be made by any process that allows well-mixing of the polyester, the copolyester-ether, the styrene-butadiene copolymer, the catalyst, and the optional additive. The process may include, for example, but is not limited to, dry mixing, melt mixing, and mixing after dissolving in a solvent. In certain embodiments, the catalyst is first compounded with the polyester to obtain a catalyst masterbatch, which is then blended with the polyester, the copolyester-ether, the styrene-butadiene copolymer, and the optional additive to obtain the polyester composition of the disclosure.

Subsequent applications of the polyester composition of the disclosure may include, but is not limited to, various molded products, such as sheets, chips, and packaging materials, which are produced using existing polyester-processing techniques. Examples of the packaging materials may include, but are not limited to, bottles, cans, bags, plates, and so on.

In particular, the packaging materials made from the polyester composition of the disclosure not only has a relatively short oxygen-scavenging induction period, but also effectively consume oxygen so as to prevent oxygen from reacting with oxygen-sensitive food. During oxygen-scavenging process, the packaging materials also consume oxygen that is originally present in the package so as to further decrease the risk of food spoilage. In addition, the packaging materials made with the polyester composition of the disclosure may have a high transparency, which is favorable to the appearance of the packages.

Examples of the disclosure will be described hereinafter. It is to be understood that these examples are exemplary and explanatory and should not be construed as a limitation to the disclosure.

### Preparative Example 1: Preparation of Catalyst Masterbatch

9850 g of polyethylene terephthalate chips (Manufacturer: Far Eastern New Century Corporation; Model: CB600H, hereinafter abbreviated as PET chips) were placed in a first tank of a co-rotating twin screw extruder (Manufacturer: Sino Alloy; Model: PSM50), and were fed through the extruder at a rotation speed of 240 rpm. 567 g of cobalt neodecanoate (Manufacturer: Seedchem) was placed in a second tank of the co-rotating twin screw extruder, and was fed through the extruder at a rotation speed of 240 rpm. PET chips and cobalt neodecanoate were compounded at a temperature of 270° C. to obtain a catalyst masterbatch. The catalyst masterbatch was then measured by an inductively coupled plasma mass spectrometer (Manufacturer: Agilent; Model: 7500ce), and an amount of cobalt contained therein ranges from 7000 parts per million (ppm) to 8000 ppm.

### Preparative Example 2: Preparation of Copolyester-ether

2300 g of dimethyl terephthalate, 820 g of ethylene glycol, 2400 g of polytetramethylene ether glycol (Manufacturer: Dairen Chemical Corporation; Model: PTG1400), and an adequate amount of catalyst (tetraisopropyl titanate, Manufacturer: Dorf Ketal) were subjected to a transesterification reaction in a reactor at a temperature of 240° C. for 4 hours while distilling out 760 g of methanol to obtain an esterification product. After that, the esterification product was subjected to a polycondensation reaction at a temperature of 270° C. for 4 hours to obtain a copolyester-ether. The amount of the polyether segment contained in the copolyester-ether was calculated as illustrated below to be 50.4 wt % based on a total weight of the copolyester-ether,

2400÷(2400+2300+820−760)×100%=50.4%

in which 2400 (g), 2300 (g), 820 (g), and 760 (g) were the amounts of polytetramethylene ether glycol, dimethyl terephthalate, ethylene glycol, and the amount of methanol distilled, respectively.

### Example 1 (EX1)

First, PET chips, the catalyst masterbatch of Preparative Example 1, the copolyester-ether of Preparative Example 2, and styrene-butadiene copolymer (Manufacturer: NEOS Styrolution; Model: 656C; intrinsic viscosity: 0.21) were respectively dried so as to achieve a moisture content of lower than 50 ppm. Next, 100 parts by weight of the PET chips, 0.5 part by weight of the styrene-butadiene copolymer, 1 part by weight of the copolyester-ether of Preparative Example 2, and 0.55 part by weight of the catalyst masterbatch of Preparative Example 1 were evenly blended using a V Type Mixer (Manufacturer: Shang Yuh Co. Ltd.) to obtain a polyester composition. After that, the polyester composition was extruded using a sheet extruder (Manufacturer: Fong Kee International Machinery Co. LTD; Model: SE-65-250PT) that is operated with a die head temperature of 270° C. and a length-diameter ratio (L/D) of a single screw of 28, so as to obtain a polyester sheet with a thickness of 0.7 mm.

### Examples 2 to 6 (EX2 to EX6) and Comparative Examples 1 to 3 (CE1 to CE3)

The procedures for preparing polyester sheets of EX2 to EX6 and CE1 to CE3 were similar to those of EX1, except that the types and amounts of the styrene-butadiene copolymers used in EX2 to EX6, and in CE2 and CE3 were varied, and styrene-butadiene copolymer was omitted in CE1 as shown in Table 1 below.

### Comparative Example 4 (CE4)

The procedures for preparing a polyester sheet of CE4 were similar to those of EX1, except that, an oxygen scavenger (Manufacturer: ColorMatrix; Model: Amosorb DFC 4020E) was used instead of the styrene-butadiene copolymer, as shown in Table 1. The oxygen scavenger is a modified copolymer including at least one polybutadiene segment.

### Property Evaluations:

1. Amount of Butadiene Monomer Unit in the Styrene-Butadiene Copolymer:

The amount of butadiene monomer unit in the styrene-butadiene copolymer used in each of EX1 to EX6, CE2 and CE3, and in the modified copolyester used in CE4 were analyzed using a nuclear magnetic resonance (NMR) spectroscopy (Manufacturer: Bruker Avance; Model: 400 MHz). The results are presented in Table 1.

2. Oxygen Transmission Rate (OTR) and Oxygen-scavenging Induction Period:

An OTR on the 0^{th} day of each of the polyester sheets of E1 to E6 and CE1 to CE4 was measured as soon as the polyester sheets were made, using an oxygen transmission rate tester (Manufacturer: MOCON; Model: OX-IRAN® 2/21) according to ASTM D3985. Subsequently, the OTR of each of the polyester sheets was measured every day until the measured OTRs values showed a downward trend, and the number of days taken when the measured OTRs of each of the polyester sheets of E1 to E6 and CE1 to CE4 showed such trend was recorded as the oxygen-scavenging induction period. A relatively lower OTR value indicates a better oxygen-scavenging efficiency. A preferable OTR value for the polyester sheets is lower than 3 c.c./m²·day. In addition, the shorter the oxygen-scavenging induction period of a polyester sheet, the faster the oxygen-scavenging thereof begins. The results are presented in Table 1.

3. Haze:

Haze of each of the polyester sheets of E1 to E6 and CE1 to CE4 was analyzed using a haze meter (Manufacturer: Nippon Denshoku; Model: NDH-2000) according to ASTM D1003. The lower the haze of the polyester sheet is, the higher the transparency is. A preferable haze value for the polyester sheet is lower than 5%. The results are presented in Table 1.

TABLE 1

| | | Styrene-butadiene copolymer/ | | | | | | |
|---|---|---|---|---|---|---|---|---|
| | | Modified copolymer including at least one polybutadiene segment | | | | | | |
| | | | | Amount of | | Property evaluation of polyester sheets | | |
| | | | Amount | butadiene | | OTR on the | Oxygen-scavenging | |
| | | | (parts | monomer unit | | 0^{th} day | induction period | Haze |
| | | Type/Manufacturer/Model | by weight) | (wt %) | IV | (c.c./m² · day) | (days) | (%) |
| EX | 1 | Styrene-butadiene copolymer | 0.5 | 15 | 0.21 | 1.0 | <1 | 3.0 |
| | | NEOS Styrolution 656C | | | | | | |
| | 2 | Styrene-butadiene copolymer | 0.5 | 23 | 0.24 | 0.7 | <1 | 3.2 |
| | | NEOS Styrolution 684D | | | | | | |
| | 3 | Styrene-butadiene copolymer | 0.5 | 38 | 0.27 | 0.7 | <1 | 4.5 |
| | | Chevron Phillips Chemical KK38 | | | | | | |
| | 4 | Styrene-butadiene copolymer | 0.5 | 24 | 0.76 | 1.1 | <1 | 3.5 |
| | | Asahi-kasei Asaflex 825 | | | | | | |
| | 5 | Styrene-butadiene copolymer | 1 | 23 | 0.24 | 0.5 | <1 | 3.2 |
| | | NEOS Styrolution 684D | | | | | | |
| | 6 | Styrene-butadiene copolymer | 3 | 23 | 0.24 | 1.1 | <1 | 3.5 |
| | | NEOS Styrolution 684D | | | | | | |
| CE | 1 | — | 0 | — | — | 3.5 | 21 | 2.8 |
| | 2 | Styrene-butadiene copolymer | 0.5 | 82 | 0.33 | 0.5 | <1 | 54.0 |
| | | Kraton DX410JS | | | | | | |
| | 3 | Styrene-butadiene copolymer | 5 | 23 | 0.24 | 1.0 | <1 | 5.3 |
| | | NEOS Styrolution 684D | | | | | | |
| | 4 | Modified copolymer including at | 0.5 | 5 | 0.50 | 0.04 | <1 | 6.0 |
| | | least one polybutadiene segment | | | | | | |
| | | ColorMatrix Amosorb DFC 4020E | | | | | | |

As shown in Table 1, in comparison to the polyester sheet of CE1, the polyester sheets of EX1 to EX6 have lower OTRs on the 0^{th} day and shorter oxygen-scavenging induction periods. In comparison to the polyester sheets of CE2 to CE4, the polyester sheets of EX1 to EX6 have lower haze value. Therefore, the results indicate that by using styrene-butadiene copolymers with an amount of butadiene monomer unit ranging from 12 wt % to 50 wt %, and an amount of styrene-butadiene copolymers ranging from 0.2 to 4 parts by weight, the polyester sheets of EX1 to EX6 can have better oxygen-scavenging efficiency and higher transparency.

In addition, the polyester sheets of EX1 to EX6 meet the industrial requirements to be applied as packaging materials, which include having haze value of lower than 5% and OTR of lower than 3 c.c./m²·day.

The polyester sheet of CE1 is lacking of styrene-butadiene copolymer, and thus has a relatively high OTR on the 0^{th} day and a relatively long oxygen-scavenging induction period of 21 days.

The polyester sheet of CE2 has a very low transparency since the amount of butadiene monomer unit in the styrene-butadiene copolymer is as high as 82 wt %.

The polyester sheet of CE3 also has a relatively low transparency since the amount of styrene-butadiene copolymer is as high as 5 parts by weight.

The polyester sheet of CE 4 is prepared by using a modified copolymer including at least one polybutadiene segment instead of a styrene-butadiene copolymer, which results in a good oxygen-scavenging efficiency. However, the polyester sheet of CE4 turns out to have a relatively low transparency.

In view of the aforesaid, in order for products (e.g., polyester sheet to be applied as packaging materials) made from the polyester composition of the disclosure to have advantages such as a relatively short oxygen-scavenging induction period and a relatively high transparency, the polyester composition should include polyester, copolyester-ether, styrene-butadiene copolymer, and catalyst, in which butadiene monomer unit of the styrene-butadiene copolymer should be in an amount ranging from 12 wt % to 50 wt %, and the styrene-butadiene copolymer should be in an amount ranging from 0.2 to 4 parts by weight based on 100 parts by weight of the polyester.

In the description above, for the purposes of explanation, numerous specific details have been set forth in order to provide a thorough understanding of the embodiments. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what are considered the exemplary embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. A polyester composition, comprising:
a polyester;
a copolyester-ether;
a styrene-butadiene copolymer; and
a catalyst,
wherein said styrene-butadiene copolymer includes a butadiene monomer unit in an amount ranging from 12 wt % to 50 wt % based on a total weight of said styrene-butadiene copolymer; and
wherein said styrene-butadiene copolymer is in an amount ranging from 0.2 to 4 parts by weight based on 100 parts by weight of said polyester.

2. The polyester composition according to claim 1, wherein the amount of said butadiene monomer unit included in said styrene-butadiene copolymer is in a range from 15 wt % to 40 wt % based on said total weight of said styrene-butadiene copolymer.

3. The polyester composition according to claim 1, wherein the amount of said styrene-butadiene copolymer is in a range from 0.5 to 3 parts by weight based on 100 parts by weight of said polyester.

4. The polyester composition according to claim 1, wherein said copolyester-ether includes a polyester segment and a polyether segment, and said polyether segment has a weight-average molecular weight ranging from 1000 g/mol to 3000 g/mol.

5. The polyester composition according to claim 1, wherein said copolyester-ether includes a polyester segment and a polyether segment, and said polyether segment is in an amount ranging from 10 wt % to 70 wt % based on a total weight of said copolyester-ether.

6. The polyester composition according to claim 1, wherein said copolyester-ether is in an amount ranging from 0.5 to 3.0 parts by weight based on 100 parts by weight of said polyester.

7. The polyester composition according to claim 1, wherein said catalyst includes a transition metal.

8. The polyester composition according to claim 7, wherein said transition metal includes cobalt.

9. The polyester composition according to claim 7, wherein said transition metal is in an amount ranging from 0.003 to 0.01 part by weight based on 100 parts by weight of said polyester.

10. The polyester composition according to claim 1, wherein said styrene-butadiene copolymer has a weight-average molecular weight ranging from 100,000 g/mol to 200,000 g/mol.
